(19) United States
(12) Patent Application Publication
(10) Pub. No.: US 2025/0036438 A1
(43) Pub. Date: Jan. 30, 2025

(54) SYSTEM AND METHOD FOR ENABLING OPERATIONS FOR VIRTUAL COMPUTING INSTANCES WITH PHYSICAL PASSTHRU DEVICES

(71) Applicant: VMWARE, INC., Palo Alto, CA (US)

(72) Inventors: Sowgandh Sunil Gadi, Palo Alto, CA (US); Petr Vandrovec, Cupertino, CA (US); Harsha Vardhan Ghanta, Palo Alto, CA (US); Arunachalam Ramanathan, Palo Alto, CA (US); Yijiang Yuan, Palo Alto, CA (US); Doug Covelli, Boston, MA (US); Balakrishna Tallapragada, Portland (CA)

(21) Appl. No.: 18/225,914

(22) Filed: Jul. 25, 2023

(51) Int. Cl. G06F 9/455

(52) U.S. Cl. CPC G06F 9/45558; G06F 2009/45562; G06F 2009/4557; G06F 2009/45583

(57) ABSTRACT

System and method for enabling operations for virtual computing instances with physical passthru devices includes moving an input-output memory management unit (IOMMU) domain from a source virtual computing instance having a physical passthru device to a destination virtual computing instance, where guest operations are performed in the source virtual computing instance. After the destinating virtual computing instance is powered on, any interrupt notifications from the physical passthru device are buffered. After memory data is transferred from the source virtual computing instance to the destination virtual computing instance, posting of interrupt notifications from the physical passthru device is resumed and any buffered interrupt notifications from the physical passthru device are posted. Guest operations are performed in the destination virtual computing instance.

### BACKGROUND

Peripheral Component Interconnect (PCI) passthrough, such as VMDirectPath Input/Output (I/O), enables direct assignment of hardware PCI Functions to virtual machines. Thus, PCI passthrough can be used to assign a PCI device (e.g., network interface adapter (NIC), a disk controller, host bus adapter (HBA), universal serial bus (USB) controller, soundcard etc.) to a virtual machine guest as a PCI passthru device, which allows full and direct access to the PCI passthru device.

For certain type of PCI passthrough, i.e., PCI fixed passthrough that uses direct PCI device assignment, there can be several problems. For example, once a vanilla VM (a VM that has no PCI passthru devices, i.e., all devices are virtual devices) is powered on, a PCI Passthru device cannot be hot-added (i.e., adding a device while the VM is running). Thus, a PCI passthru device can only be added to the VM when the VM is in power-off state, which means that the user has to power on the VM after the PCI passthru device has been added. Another possible problem is that, for a VM running with one or more PCI passthru devices, live VM reconfiguration may not be possible. Live VM reconfiguration may be required for performing operations, such as hot-add of PCI passthru devices, hot-add of virtual PCIe device, e.g., VMXNET device, and/or hot-add of memory. Still another possible problem is that, for a VM running with one or more PCI passthru devices, storage migration, such as VMware vSphere® storage vMotion® migration, may not be possible. Lastly, another possible problem is that, surprise hot-remove of PCI passthru device from a VM may make the VM and/or the host computer on which the VM is running unstable.

### SUMMARY

System and method for enabling operations for virtual computing instances with physical passthru devices includes moving an input-output memory management unit (IOMMU) domain from a source virtual computing instance having a physical passthru device to a destination virtual computing instance, where guest operations are performed in the source virtual computing instance. After the destinating virtual computing instance is powered on, any interrupt notifications from the physical passthru device are buffered. After memory data is transferred from the source virtual computing instance to the destination virtual computing instance, posting of interrupt notifications from the physical passthru device is resumed and any buffered interrupt notifications from the physical passthru device are posted. Guest operations are performed in the destination virtual computing instance.

A computer-implemented method for enabling operations for virtual computing instances with physical passthru devices in accordance with an embodiment of the invention comprises creating a destination virtual computing instance for a source virtual computing instance having a physical passthru device, wherein guest operations are performed in the source virtual computing instance; powering on the destination virtual computing instance, including moving an input-output memory management unit (IOMMU) domain from the source virtual computing instance to the destination virtual computing instance; after powering on the destinating virtual computing instance, buffering any interrupt notifications from the physical passthru device; when the interrupt notifications are being buffered, transferring memory data from the source virtual computing instance to the destination virtual computing instance; after transferring the memory data, resuming posting of interrupt notifications from the physical passthru device, including posting any buffered interrupt notifications from the physical passthru device; after resuming the posting of the interrupt notifications from the physical passthru device, shutting down the source virtual computing instance; and performing the guest operations in the destination virtual computing instance. In some embodiments, the steps of this method are performed when program instructions contained in a computer-readable storage medium are executed by one or more processors.

A system in accordance with an embodiment of the invention comprises memory and at least one processor configured to create a destination virtual computing instance for a source virtual computing instance having a physical passthru device, wherein guest operations are performed in the source virtual computing instance; power on the destination virtual computing instance, including moving an input-output memory management unit (IOMMU) domain from the source virtual computing instance to the destination virtual computing instance; after powering on the destinating virtual computing instance, buffer any interrupt notifications from the physical passthru device; when the interrupt notifications are being buffered, transfer memory data from the source virtual computing instance to the destination virtual computing instance; after the memory data is transferred, resume posting of interrupt notifications from the physical passthru device, including posting any buffered interrupt notifications from the physical passthru device; after the posting of the interrupt notifications from the physical passthru device is resumed, shut down the source virtual computing instance; and perform the guest operations in the destination virtual computing instance.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a computer system in accordance with an embodiment of the invention.

FIG. 2 is a flow diagram of an operation performed by a hypervisor with a passthru orchestrator in the computer system shown in FIG. 1 to hot-add a PCI passthru device to a VM in accordance with an embodiment of the invention.

FIGS. 3A, 3B, 3C and 3D show a swim lane diagram of an FSR operation performed by the hypervisor with the passthru orchestrator in the computer system shown in FIG. 1 in accordance with an embodiment of the invention.

FIG. 4 is a flow diagram of a hot-add operation of a Peripheral Component Interconnect (PCI) passthru device to a virtual machine (VM) without any PCI passthru device in the computer system shown in FIG. 1 in accordance with an embodiment of the invention.

FIG. 5 is a flow diagram of a storage migration of a passthru VM in the computer system shown in FIG. 1 in accordance with an embodiment of the invention.

FIG. 6 is a flow diagram of a surprise hot-remove of a PCI passthru device for a VM from the computer system in FIG. 1 in accordance with an embodiment of the invention.

FIGS. 7A and 7B show a swim lane diagram of a process of handling a hot-removal of a PCI passthru device for a VM from the computer system shown in FIG. 1 in accordance with an embodiment of the invention is shown.

FIG. 8 is a flow diagram of a computer-implemented method for enabling operations for virtual computing instances with physical passthru devices in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

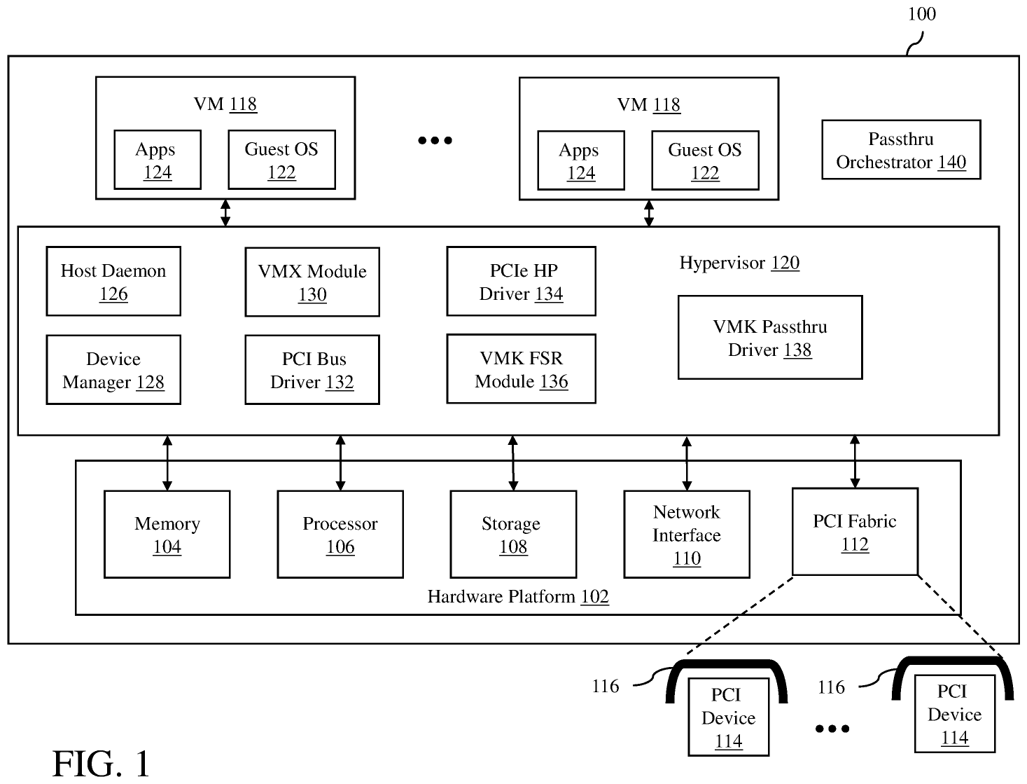

Turning now to FIG. 1, a computer system 100 in accordance with an embodiment of the invention is shown. As shown in FIG. 1, the computer system 100 includes a physical hardware platform 102, which includes components commonly found in a server-grade or personal computer. The physical hardware platform 102 includes at least one or more system memories 104, one or more processors 106, storage 108, a network interface 110, and a PCI Fabric 112. Each system memory 104, which may be random access memory (RAM), is the volatile memory of the computer system 100. Each processor 106 can be any type of a processor, such as a central processing unit (CPU) commonly found in a personal computer. The storage 108 can be any type of non-volatile computer storage with one or more storage devices, such as a solid-state devices (SSDs) and hard disks. Although the storage 108 is shown in FIG. 1 as being a local storage, in other embodiments, the storage 1108 may be a remote storage, such as a network-attached storage (NAS) or part of a storage area network (SAN). The network interface 110 is an interface that allows the computer system 100 to communicate with other devices through one or more computer networks. As an example, the network interface may be a network interface controller or card (NIC). The PCI fabric 112 is an interface to connect to Peripheral Component Interconnect (PCI) devices 114. The PCI fabric 112 may include a root complex, buses and a switch, which may be connected to PCI hot plug slots 116, so that multiple PCI devices can connected to the PCI fabric. The PCI fabric 112 may be included in a motherboard (not shown) to which the other hardware components of the computer system are connected. In an embodiment, the PCI fabric 112 supports PCI express (PCIe) and the PCI devices 114 may include PCIe devices.

The computer system 100 also includes a virtualization layer that abstracts processor, memory, storage and networking resources of the hardware platform 102 into virtual computing instances 118, e.g., virtual machines, that run concurrently on the same host. The virtual machines run on top of a software interface layer, which is referred to herein as a hypervisor 120, that enables sharing of the hardware resources of the computer system by the virtual machines. One example of the hypervisor 120 that may be used in an embodiment described herein is a VMware ESXi™M hypervisor provided as part of the VMware vSphere® solution made commercially available from VMware, Inc. The hypervisor 120 may run on top of the operating system of the computer system or directly on hardware components of the computer system. For other types of virtual computing instances, the computer system may include other virtualization software platforms to support those virtual computing instances, such as Docker virtualization platform to support “containers.” In the following description, the virtual computing instances 118 will be described as being virtual machines (VMs), which usually include guest operating systems (OSs) 122 and applications 124 running on the VMs.

The hypervisor 120 includes various components to support the VMs 118 and provide various functionalities related to the VMs. As illustrated in FIG. 1, the hypervisor 120 includes a host daemon 126, a device manager 128 and a virtual machine executable (VMX) module 130. The host daemon 126 is an application that is responsible for most of the operations on the computer system 100. The host daemon 126 knows about all the VMs that are registered on the computer system 100. The host daemon 126 also provides remote management operations from a management server, such as a VMware vCenter server, that manages the computer system 100 as part of a cluster of hosts. In particular, the host daemon 126 is able to power on or power off the VMs 118. The device manager 128 operates to manage all the physical devices connected to the computer system 100. The VMX module 130 helps to emulate the hardware resources of the computer system 100 for the VMs 118. The VMX module 130 is also responsible for communicating with user interfaces and other modules.

The hypervisor 120 further includes a PCI bus driver 132, a PCIe hot plug (HP) driver 134, a fast suspend resume (FSR) module 136 and a VM kernel (VMK) passthru driver 138. The PCI bus driver 132 is the driver for the PCI bus in the computer system 100. The PCIe HP driver 134 is the driver for the hot plug slots 116 with respect to PCI devices. The FSR module 136 enables live-VM-reconfiguration operations, which allows for hot-add of PCI passthru devices and other operations, as described below. As used herein, a PCI passthru device is a PCI device that is directly assigned to a VM using PCI passthrough technology, such as VMDirectPath Input/Output (I/O) technology. In addition, hot-add or hot-remove a device to a VM means adding or removing the device while the VM is running. The VMK passthru driver 138 is the driver for PCI passthru devices connected to the computer system 100. The hypervisor 120 may include additional components commonly found in a hypervisor that supports VMs.

The hypervisor 120 with all its components enables live-VM-reconfiguration operations for a VM, regardless of whether the VM has one or more PCI passthru devices or not. That is live-VM-reconfiguration operations are possible for a passthru VM, i.e., a VM that has one or more PCI passthru devices, as well as for a vanilla VM, i.e., a VM that does not have any PCI passthru devices. Thus, live-VM-reconfiguration operations, such as (1) hot-add of PCI passthru device(s) to a passthru VM, (2) hot-add of virtual PCIe devices, e.g., VMXNET device, to a passthru VM and (3) hot-add of memory to a passthru VM, are possible.

In an embodiment, the hypervisor 120 with the assistance from a passthru orchestrator 140 executes a live-VM-reconfiguration operation in a manner similar to the operation of a hypervisor that executes a conventional FSR operation. The passthru orchestrator 140 is an application that orchestrates at least some steps of a live-VM-reconfiguration operation. In an embodiment, the passthru orchestrator 140 may be implemented using a script from management server, such as a VMware vCenter™M server, or a UI, which may install the passthru orchestrator 140 in the computer system 100. When a user requests a live-VM-reconfiguration operation, such as hot-add of PCI passthru device(s) or hot-add of virtual PCIe device(s) to a passthru VM, the requested changes are made to a destination VM and an FSR operation is performed by the hypervisor 120, which has some differences compared to a conventional FSR operation, as described below.

The FSR differences include changes in (1) input-output memory management unit (IOMMU) domain handoff, (2) synthetic state of existing PCI passthru device(s), (3) buffering interrupts, (4) early memory handoff, and (5) PCI passthru device handoff. For IOMMU domain handoff, the IOMMU domain is moved from the source VM to the destination VM. During source VM shutdown, the IOMMU domain is not cleaned up because the domain is now owned by the destination VM. For synthetic state of existing PCI passthru device(s), the synthetic state of existing PCI passthru device(s) are saved in the source VM and restored in the destination VM. Synthetic state may include MSI, MSIX and PCIe capabilities and state. For buffering interrupts, the PCI passthru device may send interrupts but the guest OS may be in a suspended state and so the interrupts cannot be forwarded to the guest OS. In the FSR operation performed by the hypervisor 120, during a source save synchronization step, interrupt notifications for existing PCI passthru devices to guest OS are paused. New interrupts are “buffered” or temporarily stored. During a destination restore synchronization step, the device interrupt notifications is resumed and the interrupt notifications are sent for buffered interrupts. For memory handoff, in the conventional FSR operation, the destination VM could fault pages in a checkpoint restore phase, specifically when the mode is CPT_RESTORE_SYNC in accordance with one embodiment. This happens for reasons related to virtual devices trying to access VM's main memory. Such page faults are called “remote page faults” since the destination VM is not fully migrated and the memory related metadata (Page Frames or PFrames) are still not transferred to the destination. Metadata using PFrames provides the mapping between the VM's virtual memory and the actual Host Physical Pages (HPPs), which identifies the data in physical memory. So when any such page fault happens, an FSR page fault handler will allocate a new HPP and copy the contents from the source side to the newly allocated HPP and updates the destination side Guest Physical Page (GPP) to Host Physical Page (HPP) mapping. One of the key requirements whenever PCI passthru devices are attached to a VM is that the underlying GPP-to-HPP mapping should never change once they are allocated during the VM power on, since the PCI passthru device could be making direct memory access (DMA) to those HPPs at any point and any change in the mappings could lead to data corruption. So when executing an FSR operation on a VM which has a flag, e.g., a “fptHotplug” plug indicating that the VM has a PCI passthru device, the hypervisor 120 should be made aware that this VM has special requirements. In order to satisfy this requirement, in the FSR operation performed by the hypervisor 120, the point beyond which remote page faults can happen during the checkpoint restore of a VM is precisely identified and all the memory from the source side is transferred to the destination so that no remote page faults can ever happen.

For PCI passthru device handoff, in the FSR operation performed by the hypervisor 120, existing PCI passthru device(s) are registered to the destination VM although the source VM has not yet unregistered. But any hardware operations, such as device reset, allocating interrupt cookies, attaching proxy handler etc., are skipped since that is already done by the source VM. During source VM shutdown, the PCI passthru device(s) are unregistered by the source VM.

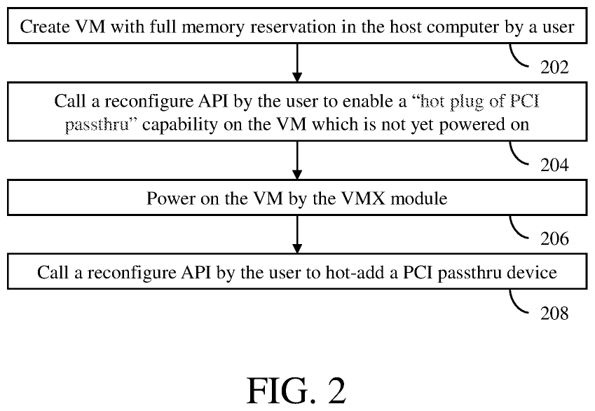

An operation performed by the hypervisor 120 with the passthru orchestrator 140 in the computer system 100 to hot-add a PCI passthru device to a VM in accordance with an embodiment of the invention is described with reference to a flow diagram of FIG. 2. The operation begins at step 202, where a VM with full memory reservation is created in the computer system 100 by a user, which may be accomplished with the help of the passthru orchestrator 140. In an embodiment, a management server, such as a VMware vCenter™ server, that manages the computer system 100 as part of a cluster of hosts or a user interface (UI) for accessing the computer system 100 may be used by the user to create the VM. Next, at step 204, a reconfigure API is called by the user via the management server or UI to enable a “hot plug of PCI passthru” capability on the VM which is not yet powered on. As part of this hot plug enablement process, it is checked whether the VM has full memory reservation, and if so, a “hot plug of PCI passthru device” setting is set true in VM configuration by the host daemon 126.

Next, at step 206, the VM is powered on by the VMX module 130. When the VM is powered on, an IOMMU is created and mapping is set up by the VMX module 130 even if there is no PCI passthru device. In addition, VM pages are pre-allocated and pinned by the VMX module 130.

Next, at step 208, a reconfigure API is called by the user via the management server or UI to hot-add a PCI passthru device. As part of this hot-add process, an FSR operation of the hypervisor 120 is started by the VMX module 130 and a destination VM is created and powered on. In addition, other steps are performed as part of the hot-add process, such as the destination VM power on, the source save synchronization step, the source save step, the destination restore step, and the destination restore synchronization step. As used herein, the source refers to the source VM and the destination refers to the destination VM. During the destination VM power on step, the source's IOMMU Domain (which has all the mappings done) is “shared” with the destination VM. In addition, a new PCI passthru and/or virtual PCIe device (which is requested by the user to hot-add) is registered to the destination VM. Furthermore, existing PCI passthru devices are registered to the destination VM, though the source VM has not yet unregistered the PCI passthru devices. However, any hardware operations, such as device reset, allocating interrupt cookies, and attaching a proxy handler etc., are skipped since those operations have already been performed by the source VM. The registering of the existing PCI passthru devices to the destination VM can be viewed as transferring ownership of the PCI passthru devices from the source VM to the destination VM.

During the source save synchronization step, interrupt notifications for existing PCI passthru devices are suspended. In addition, new interrupts are buffered. During the source save step, the synthetic state of the existing PCI passthru is saved. During the destination restore step, the synthetic state of the existing PCI passthru devices is restored. In addition, an early memory handoff (described above) is done, which will avoid demand page faults.

During the destination restore synchronization step, existing PCI passthru devices' interrupt notifications are resumed. In addition, any buffered interrupt notifications are sent to the guest OS. After the destination restore synchronization step, the destination VM is resumed and the source VM is shut down. However, hardware operations, such as unmapping and destroying the IOMMU domain, device reset, detaching the interrupt proxy handler, and freeing interrupt cookies etc., are skipped by the source VM.

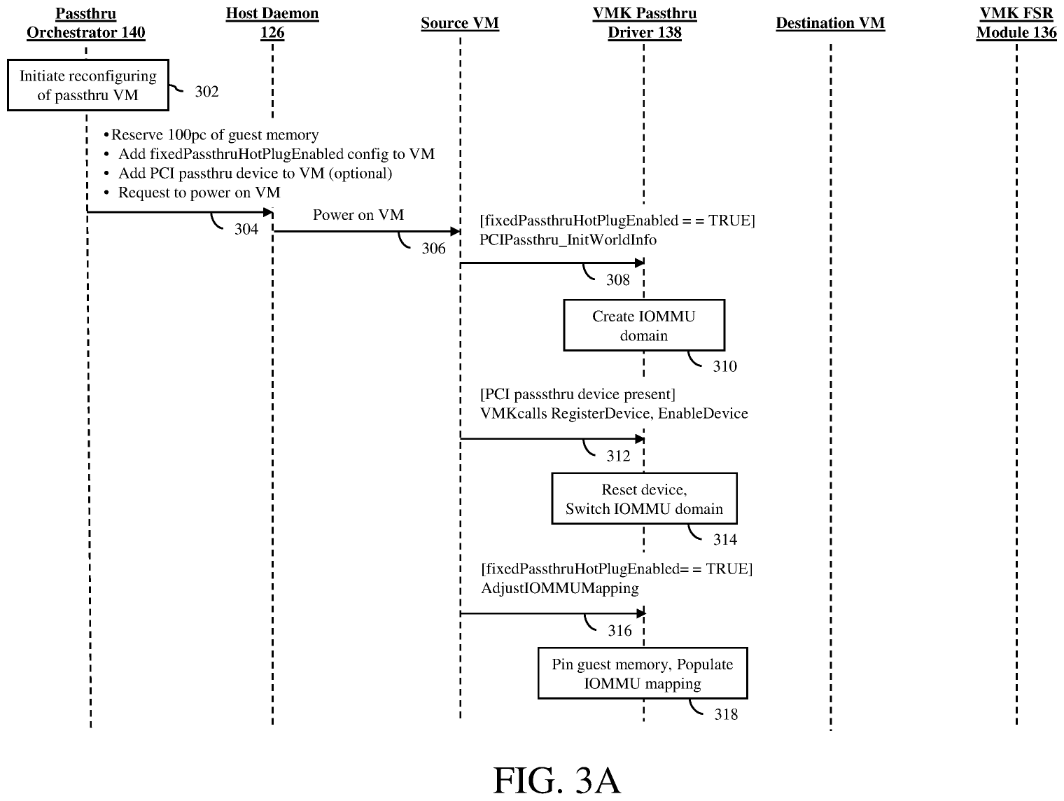

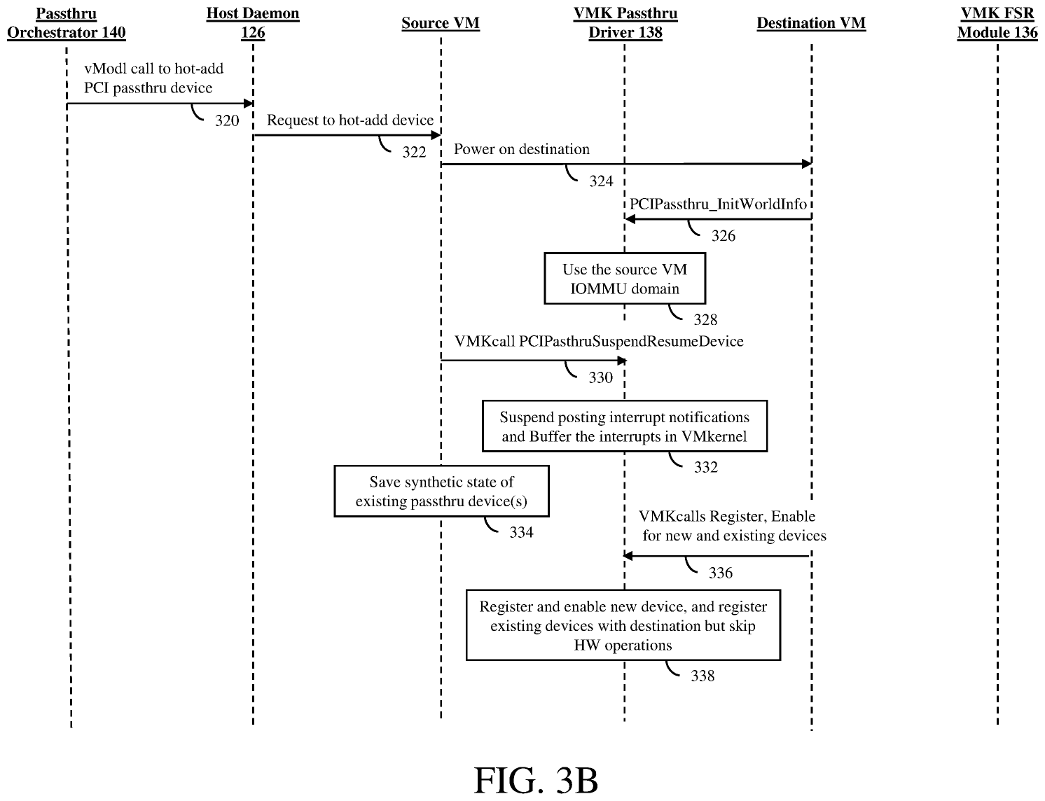

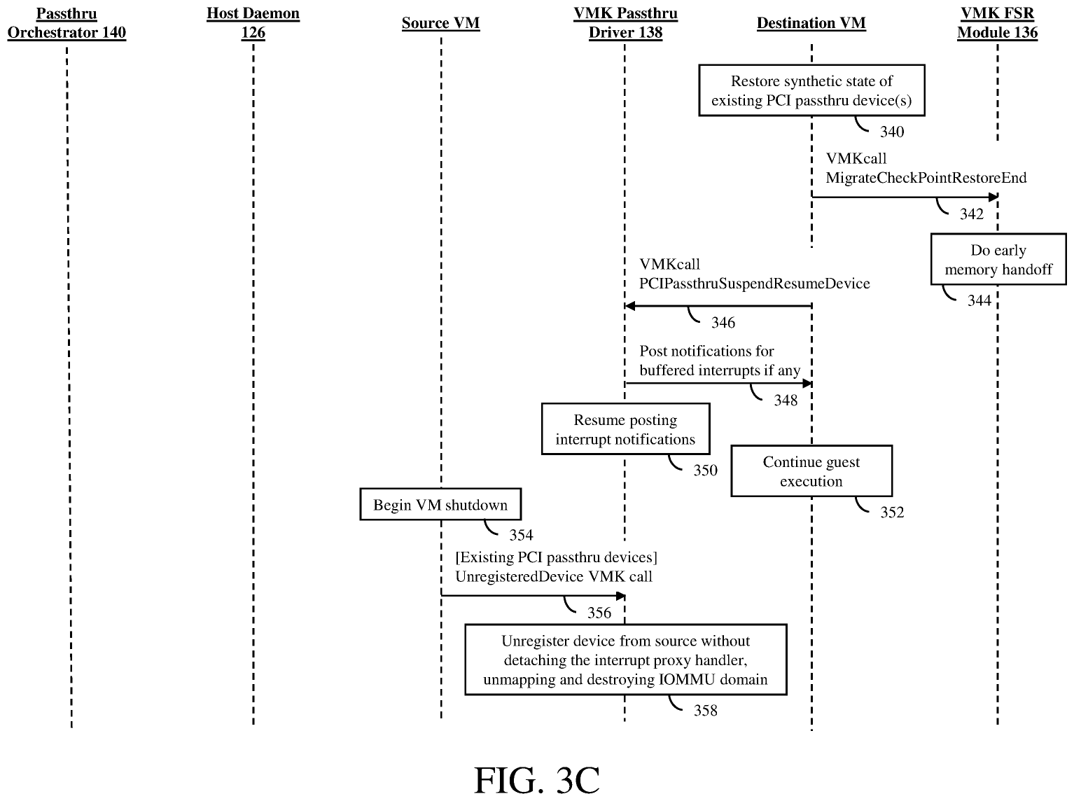

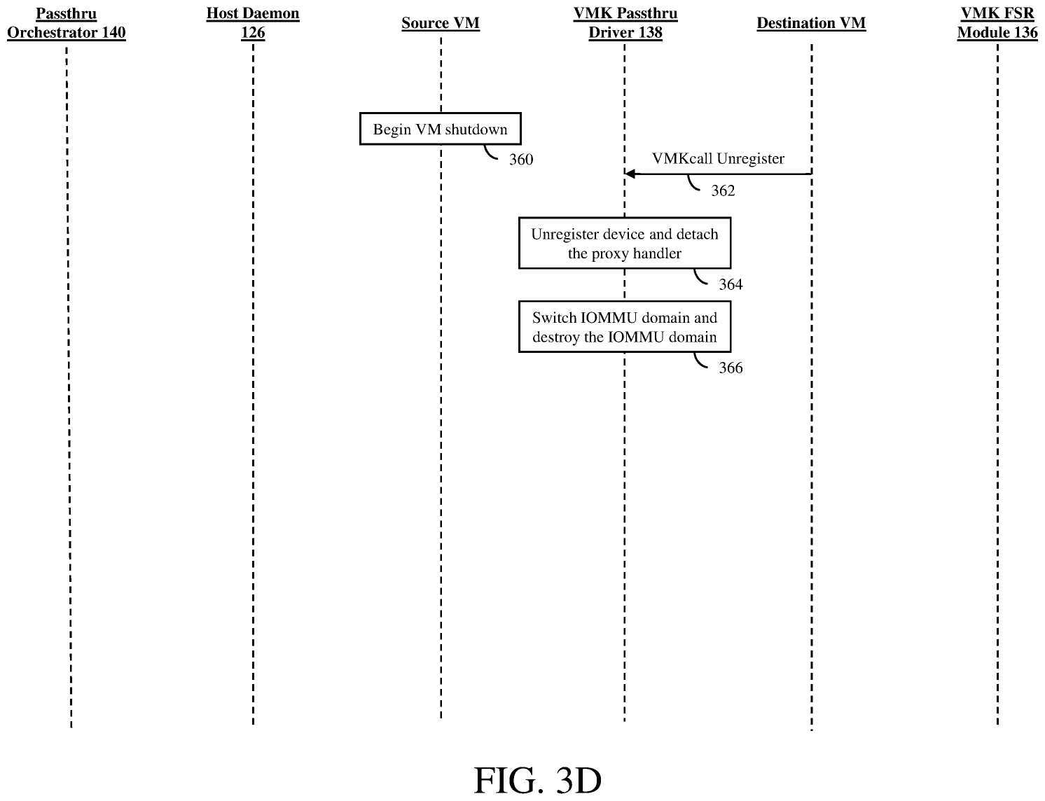

Turning now to FIGS. 3A, 3B, 3C and 3D, a swim lane diagram of an FSR operation performed by the hypervisor 120 with the passthru orchestrator 140 in the computer system 100 in accordance with an embodiment of the invention is shown. The operation begins at step 302, where a reconfiguring of the passthru VM is initiated by the passthru orchestrator 140. In an embodiment, the passthru orchestrator 140 may be executed using a script from a management server. Next, at step 304, instructions are sent to the host daemon 126 from the passthru orchestrator 140. In an embodiment, the instructions include an instruction to reserve specified amount of guest memory, such as 100 percent of size of memory configured for the VM, an instruction to add “fixed passthru hot plug enabled” (fixedPassthruHotPlugEnabed) configuration to a destination VM, and an optional instruction to add PCI passthru device to the destination VM.

At step 306, an instruction to power on the source VM is transmitted to the source VM from the host daemon 126. The source VM is the passthru VM being reconfigured. Next, in response to the instruction to power on the VM, steps 308-316 are performed. At step 308, when fixedPassthruHotPlugEnabed is true, an instruction is sent to the VMK passthru driver 138 from the source VM to create an IOMMU domain. In an embodiment, the instruction may be issued via an API, e.g., an API named “PCIPasstru_InitWorldInfo”. Next, at step 310, in response to the instruction from the source VM, an IOMMU domain is created by the VMK passthru driver 138.

At step 312, when a PCI passthru device is present, an instruction is sent to the VMK passthru driver 138 from the source VM to reset the device and switch the IOMMU domain. In an embodiment, the instruction may be issued via APIs, e.g., APIs named “RegisterDevice” and “EnableDevice”. Next, at step 314, in response to the instruction from the source VM, the device is reset and the IOMMU domain is switched by the VMK passthru driver 138. The device is reset to ensure that there is no state information remaining in the device from a previous use. The IOMMU domain is switched from the global IOMMU domain to the newly created domain.

At step 316, when fixedPassthruHotPlugEnabled is true, an instruction is sent to the VMK passthru driver 138 from the source VM to adjust the IOMMU mappings. In an embodiment, the instruction may be issued via an API, e.g., an API named “AdjustIOMMUMappings”. Next, at step 318, in response to the instruction from the source VM, the guest memory is pinned and the IOMMU mappings are populated by the VMK passthru driver 138. The IOMMU mappings are GPP-to-HPP mappings.

Next, at step 320, an instruction is sent from the passthru orchestrator 140 to the host daemon 126 to hot-add a PCI passthru device. In an embodiment, the instruction may be issued via an API, e.g., an API named “vModl” when a user wants to hot-add a PCI passthru device. Next, at step 322, in response to the instruction from the passthru orchestrator 140, a request to hot-add a device is sent from the host daemon 126 to the source VM. Next, at step 324, in response to the instruction to hot-add a device, the destination VM is powered on by the source VM. Next, at step 326, an instruction is sent to the VMK passthru driver 138 from the destination VM for IOMMU domain. In an embodiment, the instruction may be issued via an API, e.g., an API named “PCIPasstru_InitWorldInfo”. At step 328, in response to the instruction from the destination VM, the source VM IOMMU domain is used for the destination VM.

Next, at step 330, an instruction is sent to the VMK passthru driver 138 from the source VM to suspend/resume the device. In an embodiment, the instruction may be issued via an API, e.g., an API named “PCIPassthruSuspendResumeDevice”. At step 332, in response to the instruction from the source VM, posting interrupt notifications are suspended at the source VM and the interrupts are buffered in the VMkernel passthru driver 138. At step 334, the synthetic state of each existing passthru device is saved by the source VM.

Next, at step 336, an instruction is sent to the VMK passthru driver 138 from the destination VM to register and enable any new and existing devices, which include PCI passthru devices. In an embodiment, the instruction may be issued via VMK APIs, e.g., APIs named “Register” and “Enable”. At step 338, for any new device, the device is registered and enabled by the VMK passthru driver 138. However, the existing device is registered with the destination VM without performing HW operations, such as reset and switching IOMMU domain. That is, the HW operations are skipped. As noted above, the registering of the existing device to the destination VM can be viewed as transferring ownership of the existing device from the source VM to the destination VM.

Next, at step 340, the synthetic state of each existing PCI passthru device is restored by the destination VM. Next, at step 342, an instruction is sent to the VMK FSR module 136 from the destination VM to execute early memory handoff. In an embodiment, the instruction may be issued via an API, e.g., an API named “MigrateCheckPointRestoreEnd”. This moment is the point of no return for the operation. Next, at step 344, in response to the instruction from the destination VM, an early memory handoff is executed by the VMK FSR module 136.

Next, at step 346, an instruction is sent to the VMK passthru driver 138 from the destination VM to resume the suspended device. In an embodiment, the instruction may be issued via an API, e.g., an API named “PCIPassthruSuspendResumeDevice”. Next, at step 348, any notifications for the buffered interrupts are posted by the VMK passthru driver 138. Next, at step 350, posting of interrupt notifications are resumed by the VMK passthru driver 138. At step 352, any guest executions (processes being performed by the guest OS) are allowed to continue by the destination VM.

Next, at step 354, a shutdown of the source VM is initiated by the source VM. Next, at step 356, an instruction is sent to the VMK passthru driver 138 from the source VM to unregister each existing PCI passthru device. In an embodiment, the instruction may be issued via a VMK API, e.g., an API named “UnregisterDevice”. Next, at step 358, in response to the instruction, the device is unregistered from the source VM. However, the interrupt proxy handler is not detached and the IOMMU domain is not unmapped or destroyed. Next, at step 360, the shutdown of the source VM is exited by the source VM. In the destination VM, guest processes continue to run until an administrator decides to manually shut down the destination VM.

When a manual shutdown is requested, an instruction is sent to the VMK passthru driver 138 from the destination VM for shutdown, at step 362. In an embodiment, the instruction may be issued via an API, e.g., an API named “UnregisterDevice”. Next, at step 364, in response to the instruction, the device is unregistered from the destination VM and the interrupt proxy handler is detached. In addition, at step 366, the IOMMU domain is switched back to the global IOMMU domain for the device and the newly created IOMMU domain is destroyed.

For a hot-add of memory to a passthru VM, the above FSR operation is also used. However, all pages of newly added memory are pre-allocated and pinned during the FSR operation. In addition, IOMMU mappings are populated for newly added HPPs during the FSR operation.

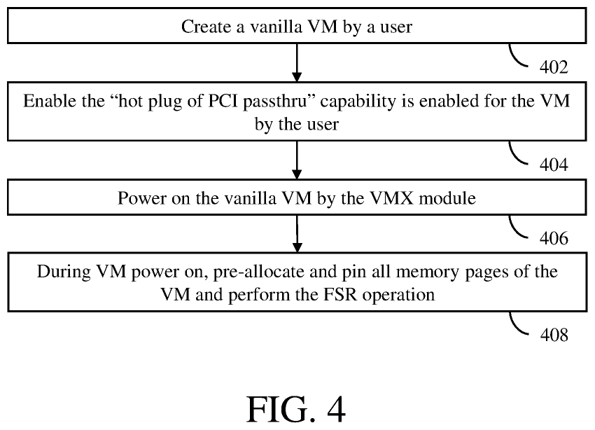

In an embodiment, a VM without any PCI passthru device, i.e., a vanilla VM, can be powered on with “Hotplug of PCI Passthru” capability and then a passthru device can be hot added. A hot-add operation of a PCI passthru device to a VM without any PCI passthru device, i.e., a vanilla VM, in the computer system 100 in accordance with an embodiment of the invention is described with reference to a flow diagram of FIG. 4. The hot-add operation begins at step 402, where a vanilla VM is created in the computer system 100 by a user. In an embodiment, the vanilla VM is created and registered using a management server, e.g., a VMware vCenter™ server. Next, at step 404, the “hot plug of PCI passthru” capability is enabled for the VM by the user. In an embodiment, this capability is enabled through the management server or through a UI. Next, at step 406, the vanilla VM is powered on by the VMX module 130. During VM power on, at step 408, all memory pages of the VM are pre-allocated and pinned and the FSR operation is performed, as described above.

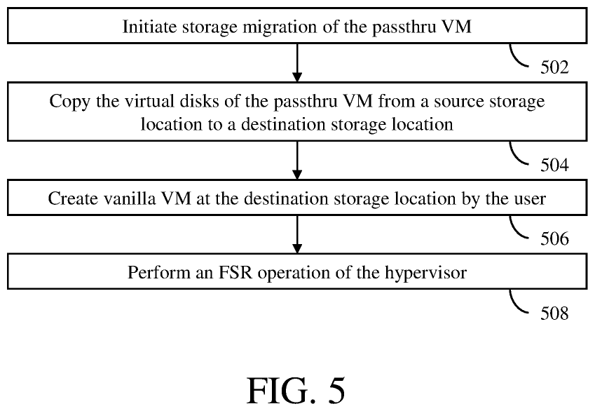

A storage migration of a passthru VM in the computer system 100 in accordance with an embodiment of the invention is described with reference to a flow diagram of FIG. 5. As an example, the storage migration may be VMware vSphere® storage vMotion® migration. The storage migration operation begins at step 502, where a storage migration of the passthru VM is initiated. The storage migration may be initiated by a user using a management server, e.g., a VMware vCenter™ server, or a UI, or may be initiated by some computer process. Next, at step 504, the virtual disks of the passthru VM are copied from a source storage location to a destination storage location. Next, at step 506, a vanilla VM is created at the destination storage location by the user. In an embodiment, the vanilla VM is created and registered using the management server. Next, at step 508, an FSR operation of the hypervisor 120 is performed.

A surprise hot-remove of a PCI passthru device for a VM from the computer

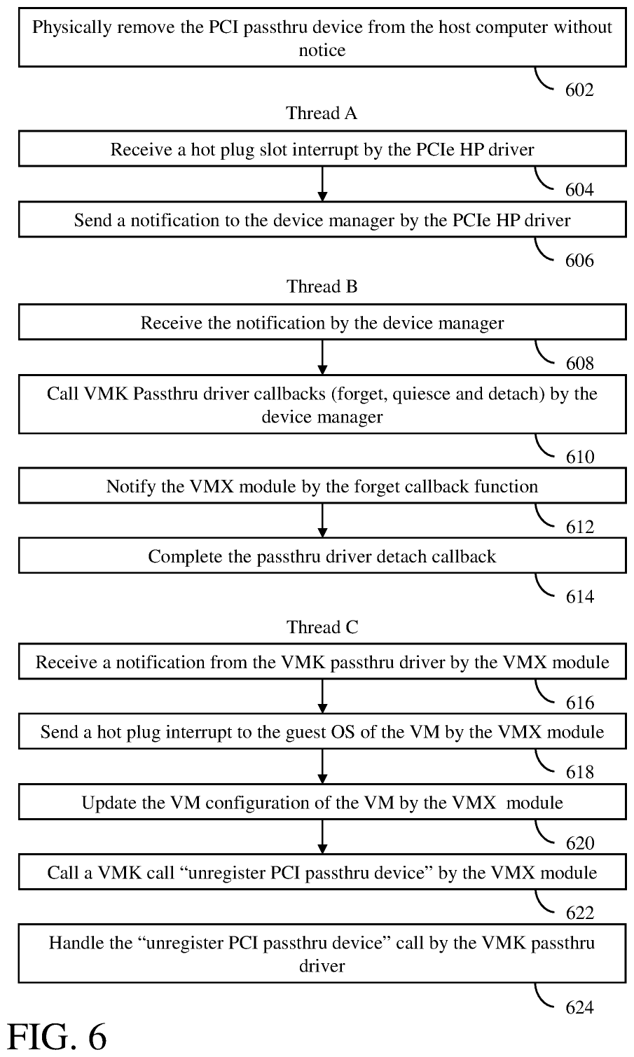

system 100 in accordance with an embodiment of the invention is described with reference to a flow diagram of FIG. 6. The hot-remove operation begins at step 602. where the PCI passthru device is physically removed from the computer system 100 without notice, i.e., the removal is a surprise. Surprise hot-remove is a hot-plug operation where the device is physically removed from a host computer without any prior warning or notification to software, such as host OS, device drivers, VM or applications. In response to the surprise hot-removal of the PCI passthru device, threads A, B and C are executed.

In thread A, at step 604, a hot plug slot interrupt is received by the PCIe HP driver 134, which handles the surprise removal of the PCI passthru device. Next, at step 606, a notification is sent to the device manager 128 by the PCIe HP driver 134.

In thread B, at step 608, the notification from the PCIe HP driver 134 is received by the device manager 128. Next, at step 610, VMK Passthru driver callbacks, i.e., forget, quiesce and detach callbacks, are called by the device manager 128. In thread B, at step 612, the VMX module 130 is notified by the forget callback function of the VMK passthru driver 138. Next, at step 614, the passthru driver detach callback is completed by the VMK passthru driver 138.

In thread C, at step 616, a notification from the VMK passthru driver 138 is received by the VMX module 130. Next, at step 618, a hot plug interrupt is sent to the guest OS of the VM by the VMX module 130. Next, at step 620, the VM configuration of the VM is updated by the VMX module 130. Next, at step 622, a VMK call “unregister PCI passthru device” is called by the VMX module 130. In thread C, at step 624, the “unregister PCI passthru device” call is handled by the VMK passthru driver 138. The unregister calls enable a cleanup process.

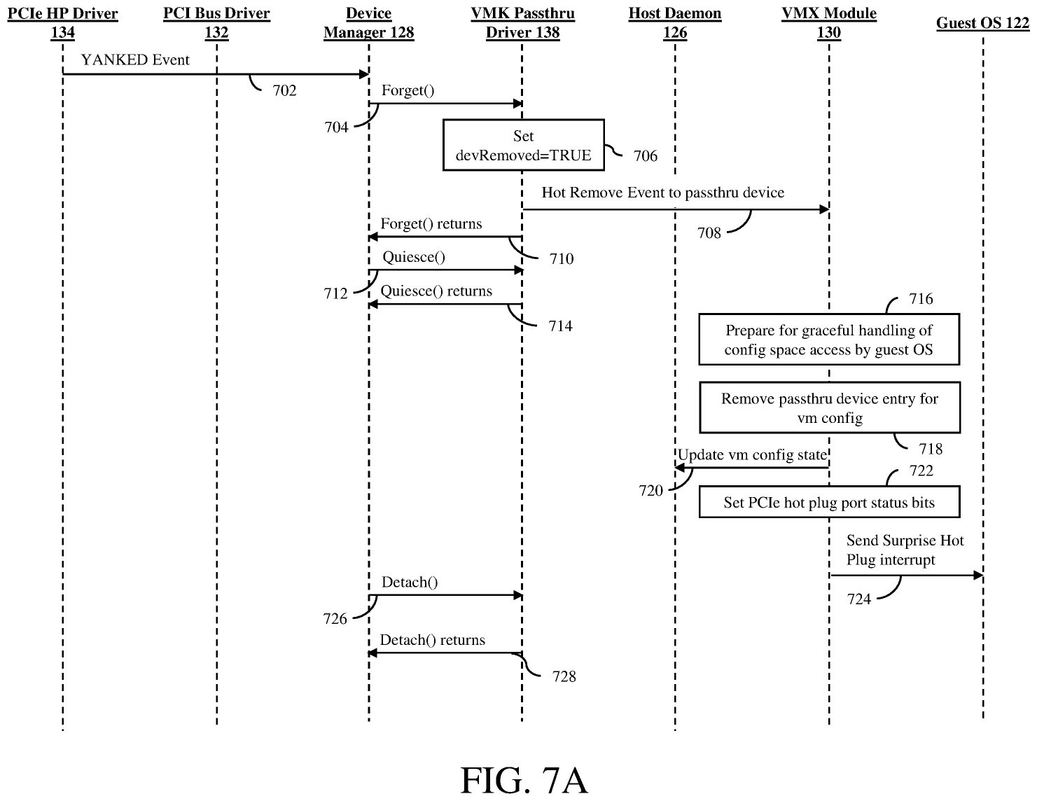

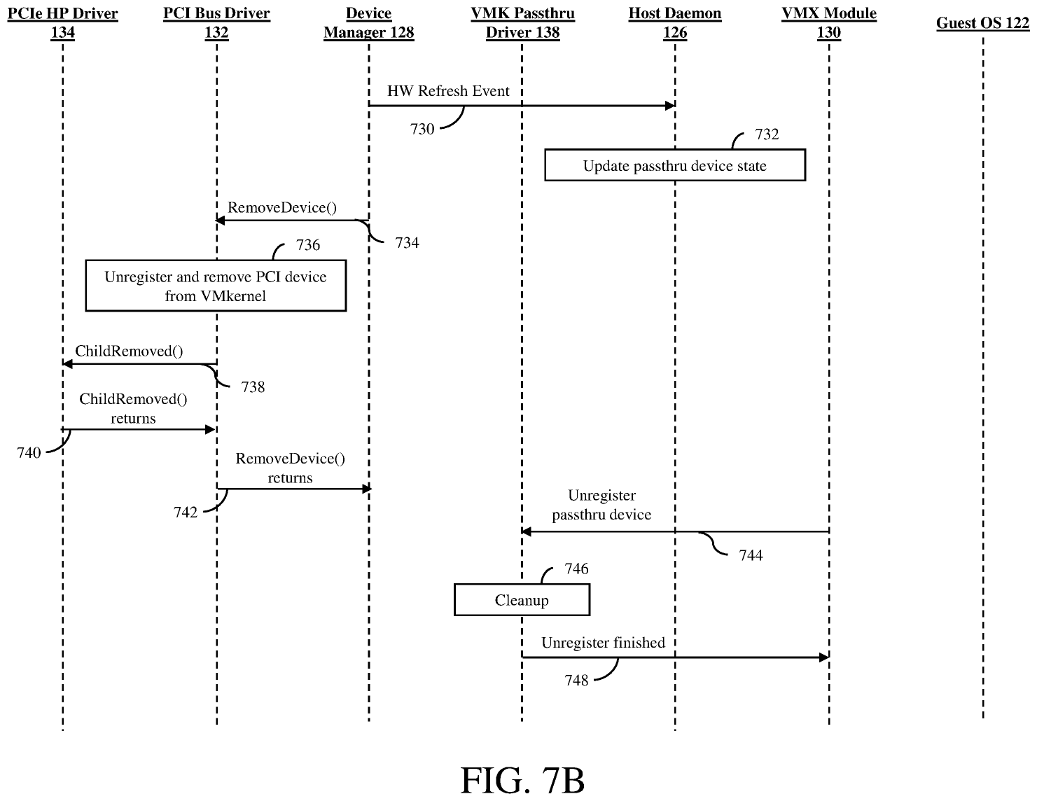

Turning now to FIGS. 7A and 7B, a swim lane diagram of a process of handling a hot-removal of a PCI passthru device for a VM from the computer system 100 in accordance with an embodiment of the invention is shown. The process begins at step 702, where a hot-removal event notification (“YANKED Event”) is sent to the device manager 128 from the PCIe HP driver 134 when the PCI passthru device assigned to the VM is physically removed from the computer system 100. Next, at step 704, a function forget() is called to the VMK passthru driver 138 from the device manager 128. At step 706 in response to the function forget() the “device removed” (devRemoved) state is set true by the VMK passthru driver 138. Next, at step 708, a hot remove event notification is sent to the VMX module 130 from the VMK passthru driver 138.

Next, at step 710, the forget() call is returned to the device manager 128 by the VMK passthru driver 138 with a notification, which may be a success or failure notice. Next, at step 712, a quiesce() function is called to the VMK passthru driver 138 from the device manager 128 to pause or stop any operations to the PCI passthru device. At step 714, the quiesce() call is returned to the device manager 128 by the VMK passthru driver 138 with a notification, which may be a success or failure notice.

Next, at step 716, after the hot remove event notification is received by the VMX module 130, a preparation is made by the VMX module 130 for graceful handling of configuration space access by the guest OS of the VM. In addition, at step 718, a passthru device entry is removed from the VM configuration of the VM by the VMX module 130.

Next, at step 720, an instruction is sent to the host daemon 126 from the VMX module 130 to update the VM configuration state. Next, at step 722, PCIe hot plug port status bits are set by the VMX module 130 to indicate the removal of the PCI passthru device from a particular hot plug port or slot. Next, at step 724, a surprise hot plug interrupt is sent to the guest OS of the VM from the VMX module 130.

Next, at step 726, a detach() function is called to the VMK passthru driver 138 from the device manager 128. Next, at step 728, the detach() call is returned to the device manager 128 from the VMK passthru driver 138 with a notification, which may be a success or failure notice. Next, at step 730, a hardware (HW) refresh event notification is sent to the host daemon 126 from the device manager 128. In response, at step 732, the state of the passthru device is updated by the host daemon.

Next, at step 734, a RemoveDevice() function is called to the PCI bus driver 132 from the device manager. Next, at step 736, the PCI passthru device is unregistered and removed from VM kernel by the PCI bus driver 132. Next, at step 738, a ChildRemoved() function is called to the PCIe HP driver 134 from the PCI bus driver 132. Next, at step 740, the ChildRemoved() call is returned to the PCI bus driver 132 from the PCIe HP driver 134 with a notification, which may be a success or failure notice. In addition, at step 742, the RemoveDevice() call is returned to the device manager 128 from the PCI bus driver 132 with a notification, which may be a success or failure notice.

Next, at step 744, an instruction to unregister the PCI passthru device is transmitted to the VMK passthru driver 138 from the VMX module 130. In response, at step 746, a cleanup operation is executed by the VMK passthru driver 138 with respect to the removed PCI passthru device.

Next, at step 748, a notification is sent to the VMX module 130 from the VMK passthru driver 138 that the unregister process is finished. The surprise hot remove is now complete and the VM will continue running.

Using the process described herein, workflows for VM power on, hot-add of a PCI passthru device and surprise hot-remove of a PCI passthru device in accordance with an embodiment of the invention are briefly described. The VM power on workflow involves at least the passthru orchestrator 140. Before the VM is powered on, 100pc memory reservation of guest memory is selected, “fixedPasthruHotPlugEnabled” configuration specification to the VM is set and any passthru enabled devices are added to the VM (optional). The VM is then powered on.

The hot-add of a PCI passthru device workflow involves at least an administrator, the passthru orchestrator 140 and the hypervisor 120. First, one or more devices are physically inserted into one or more empty PCI hot plug slots 116 by the administrator. Each newly added device is detected, passthru is enabled for the devices and the devices are hot-added to a VM by the passthru orchestrator 140. The guest OS of the VM is notified by the hypervisor 120 of the hot-add.

The surprise hot-remove of a PCI passthru device workflow involves at least an administrator and the hypervisor 120. First, the PCI passthru device to be hot-removed is identified by the administrator. The PCI passthru device is then surprise hot-removed from a PCI hot plug slot 116 by the administrator. The guest OS of the VM is notified by the hypervisor 120 of the hot-remove.

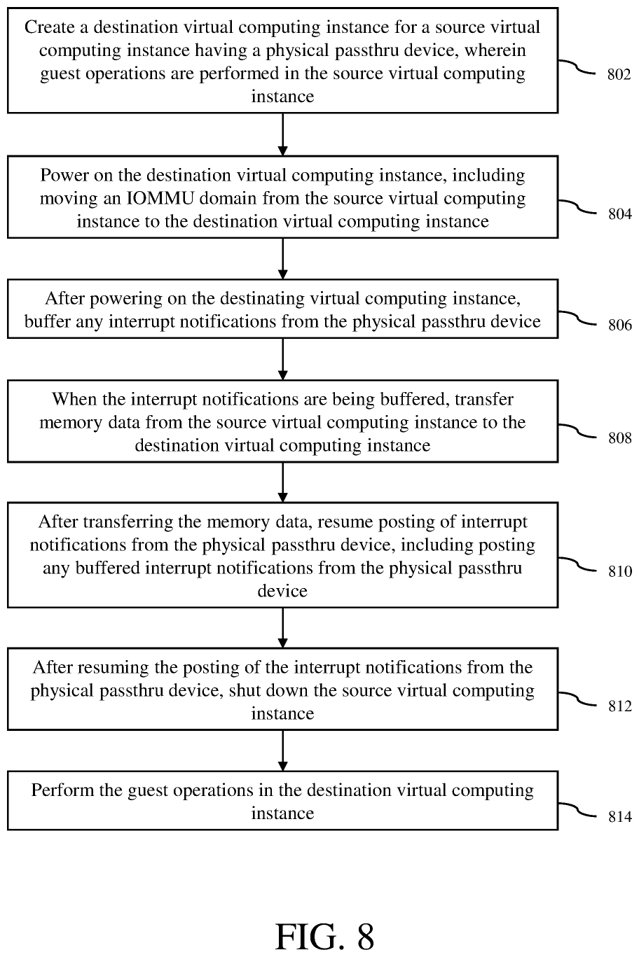

A computer-implemented method for enabling operations for virtual computing instances with physical passthru devices in accordance with an embodiment of the invention is described with reference to a flow diagram of FIG. 8. At block 802, a destination virtual computing instance is created for a source virtual computing instance having a physical passthru device, wherein guest operations are performed in the source virtual computing instance. At block 804, the destination virtual computing instance is powered on. In addition, an input-output memory management unit (IOMMU) domain is moved from the source virtual computing instance to the destination virtual computing instance. At block 806, after powering on the destinating virtual computing instance, any interrupt notifications from the physical passthru device are buffered. At block 808, when the interrupt notifications are being buffered, memory data is transferred from the source virtual computing instance to the destination virtual computing instance. At block 810, after transferring the memory data, posting of interrupt notifications from the physical passthru device is resumed. In addition, any buffered interrupt notifications from the physical passthru device are posted. At block 812, after resuming the posting of the interrupt notifications from the physical passthru device, the source virtual computing instance is shut down. At block 814, the guest operations are performed in the destination virtual computing instance.

The components of the embodiments as generally described in this document and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for enabling operations for virtual computing instances with physical passthru devices, the method comprising:
creating a destination virtual computing instance for a source virtual computing instance having a physical passthru device, wherein guest operations are performed in the source virtual computing instance;
powering on the destination virtual computing instance, including moving an input-output memory management unit (IOMMU) domain from the source virtual computing instance to the destination virtual computing instance;
after powering on the destinating virtual computing instance, buffering any interrupt notifications from the physical passthru device;
when the interrupt notifications are being buffered, transferring memory data from the source virtual computing instance to the destination virtual computing instance;
after transferring the memory data, resuming posting of interrupt notifications from the physical passthru device, including posting any buffered interrupt notifications from the physical passthru device;
after resuming the posting of the interrupt notifications from the physical passthru device, shutting down the source virtual computing instance; and
performing the guest operations in the destination virtual computing instance.

2. The computer-implemented method of claim 1, wherein the physical passthru device is a Peripheral Component Interconnect (PCI) passthru device.

3. The computer-implemented method of claim 1, further comprising saving a synthetic state of the physical passthru device in the source virtual computing instance and restoring the saved synthetic state of the physical passthru device in the destination virtual computing instance before transferring the memory data.

4. The computer-implemented method of claim 1, further comprising, before transferring the memory data, transferring ownership of the physical passthru device from the source virtual computing instance to the destination virtual computing instance.

5. The computer-implemented method of claim 4, wherein transferring the ownership of the physical passthru device includes registering the physical passthru device with the destination virtual computing instance without executing hardware operations before the physical passthru device is unregistered with the source virtual computing instance.

6. The computer-implemented method of claim 1, further comprising copying a virtual disk of the source virtual computing instance from a source storage location to a destination storage location before creating the destination virtual computing instance for the source virtual computing instance having the physical passthru device to perform storage migration.

7. The computer-implemented method of claim 1, further comprising making a user-requested change to the destination virtual computing instance, wherein the user-requested change includes hot-add of another physical passthru device to the source virtual computing instance, hot-add of a virtual device to the source virtual computing instance or hot-add of memory to the source virtual computing instance.

8. The computer-implemented method of claim 1, wherein shutting down the source virtual computing instance is performed without a cleanup of the IOMMU domain since the IOMMU domain has been moved to the destination virtual computing instance.

9. A non-transitory computer-readable storage medium containing program instructions for enabling operations for virtual computing instances with physical passthru devices, wherein execution of the program instructions by one or more processors of a computer system causes the one or more processors to perform steps comprising:
creating a destination virtual computing instance for a source virtual computing instance having a physical passthru device, wherein guest operations are performed in the source virtual computing instance;
powering on the destination virtual computing instance, including moving an input-output memory management unit (IOMMU) domain from the source virtual computing instance to the destination virtual computing instance;
after powering on the destinating virtual computing instance, buffering any interrupt notifications from the physical passthru device;
when the interrupt notifications are being buffered, transferring memory data from the source virtual computing instance to the destination virtual computing instance;
after transferring the memory data, resuming posting of interrupt notifications from the physical passthru device, including posting any buffered interrupt notifications from the physical passthru device;
after resuming the posting of the interrupt notifications from the physical passthru device, shutting down the source virtual computing instance; and
performing the guest operations in the destination virtual computing instance.

10. The computer-readable storage medium of claim 9, wherein the physical passthru device is a Peripheral Component Interconnect (PCI) passthru device.

11. The computer-readable storage medium of claim 9, wherein the steps further comprise saving a synthetic state of the physical passthru device in the source virtual computing instance and restoring the saved synthetic state of the physical passthru device in the destination virtual computing instance before transferring the memory data.

12. The computer-readable storage medium of claim 9, wherein the steps further comprise, before transferring the memory data, transferring ownership of the physical passthru device from the source virtual computing instance to the destination virtual computing instance.

13. The computer-readable storage medium of claim 12, wherein transferring the ownership of the physical passthru device includes registering the physical passthru device with the destination virtual computing instance without executing hardware operations before the physical passthru device is unregistered with the source virtual computing instance.

14. The computer-readable storage medium of claim 9, wherein the steps further comprise copying a virtual disk of the source virtual computing instance from a source storage location to a destination storage location before creating the destination virtual computing instance for the source virtual computing instance having the physical passthru device to perform storage migration.

15. The computer-readable storage medium of claim 9, wherein the steps further comprise making a user-requested change to the destination virtual computing instance, wherein the user-requested change includes hot-add of another physical passthru device to the source virtual computing instance, hot-add of a virtual device to the source virtual computing instance or hot-add of memory to the source virtual computing instance.

16. The computer-readable storage medium of claim 9, wherein shutting down the source virtual computing instance is performed without a cleanup of the IOMMU domain since the IOMMU domain has been moved to the destination virtual computing instance.

17. A computer system comprising:
memory; and
at least one processor configured to:
create a destination virtual computing instance for a source virtual computing instance having a physical passthru device, wherein guest operations are performed in the source virtual computing instance;
power on the destination virtual computing instance, including moving an input-output memory management unit (IOMMU) domain from the source virtual computing instance to the destination virtual computing instance;
after powering on the destinating virtual computing instance, buffer any interrupt notifications from the physical passthru device;
when the interrupt notifications are being buffered, transfer memory data from the source virtual computing instance to the destination virtual computing instance;
after the memory data is transferred, resume posting of interrupt notifications from the physical passthru device, including posting any buffered interrupt notifications from the physical passthru device;
after the posting of the interrupt notifications from the physical passthru device is resumed, shut down the source virtual computing instance; and
perform the guest operations in the destination virtual computing instance.

18. The computer system of claim 17, wherein the physical passthru device is a Peripheral Component Interconnect (PCI) passthru device.

19. The computer system of claim 17, wherein the at least one processor is configured to save a synthetic state of the physical passthru device in the source virtual computing instance and restore the saved synthetic state of the physical passthru device in the destination virtual computing instance before transferring the memory data.

20. The computer system of claim 17, wherein the at least one processor is configured to, before the memory data is transferred, transfer ownership of the physical passthru device from the source virtual computing instance to the destination virtual computing instance.
